(19) United States
(12) Patent Application Publication
(10) Pub. No.: US 2023/0274335 A1
(43) Pub. Date: Aug. 31, 2023

(54) FAST FOOD AND BEVERAGE PROVISION SYSTEM AND ARRANGEMENT

(71) Applicant: MYVENUE PTY LTD, Adelaide, South Australia (AU)

(72) Inventor: Tim Stollznow, Adelaide, South Australia (AU)

(73) Assignee: MYVENUE PTY LTD, Adelaide, South Australia (AU)

(21) Appl. No.: 18/005,636

(22) PCT Filed: Jul. 16, 2021
(86) PCT No.: PCT/AU2021/050769

§ 371 Date: Jan. 16, 2023

(30) Foreign Application Priority Data
Jul. 16, 2020 (AU) 2020902464

(51) Int. Cl. G06Q 30/0601; G06Q 50/12

(52) U.S. Cl. CPC G06Q 30/0633; G06Q 50/12; G06Q 20/322

(57) ABSTRACT

Described is an food and beverage product provisioning system to enable a patron to use a mobile computer device application to create and communicate an order for one or more products or services available from any outlet they intend to purchase. The system comprises: a back-end computer server adapted to receive the communicated order from the patron and dynamically adjust the time and outlet location prediction of the pick-up of the order based on patron behaviour after the patrons order is received. The system further comprises at least one order display device being located at each outlet, configured to receive information representative of a) an order for product or services; b) the patron associated with the order; c) a indictor to commence the preparation of the order at the time of receipt or at a future time, wherein the fulfilment of the order or lack of fulfilment of the order is at least one aspect of that patrons behaviour used in the time and outlet location prediction of the pick-up of the order.

### PRIORITY DOCUMENT

The present application claims priority from Australian Provisional Patent Application No. 2020902464 titled “FAST FOOD AND BEVERAGE PROVISION SYSTEM AND ARRANGEMENT” and filed on 16 Jul. 2020; the content of which is hereby incorporated by reference in its entirety.

### FIELD OF THE DISCLOSURE

The field of the disclosure is systems used to provision fast food and beverages.

### BACKGROUND

Fast food and beverage provision is a required service at entertainment venues and is traditionally a profitable aspect of the delivery of sports and music entertainment.

There are a variety of ways in which food and beverages can be provided to patrons not only in a venue setting but at any gathering of people, for example, in a hotel having multiple bars and food outlets.

In the simplest but ultimately the most wasteful of patron time and provider resources is to have a patron line-up at the outlet that provides a range of food and beverages and then decide what food and beverages they want. The serving staff at the outlet that greets the patron then needs to initiate an order and gather the requested food and beverage ordered. The outlet staff member then tallies the total of the order. The patron may or may not be ready to pay for the order but having done so, gathers the food and beverages and leaves. Time delays can occur while: the patron decides what they want or their companion/s want; at times the outlet staff member needs to find and present the products and bottled beverage or pour the beverage and present them to the patron; the patron needs to know the total monies to be paid and decide whether to pay in cash which involves counting the notes and sometimes coins, pay by credit card or some other charge card/device (often encouraged or forced on patrons to eliminate the delay of cash transactions), the card system which may or may not require a Personal Identification Number entry to the Electronic Funds Transfer device; collection of the food and beverage so that it can be carried by the patron; the patron turning and walking out of the way of the next patron waiting in line; there may however, not be a line but a large quantity of patrons trying to get the attention of the wait staff as soon as they appear to be available to take the next order (the latter arrangement sometimes leading to disputes and further delays for patrons and staff).

The manner in which patrons attend events and sporting events and then typically randomly, or by way of habit, choose an outlet to obtain food and beverages can greatly disadvantage the provider, since the provider needs to guess based on many variables what demand there will be for a large variety of products and beverages. The previous event's record of consumption of food and beverages from each outlet is not necessarily a good way to estimate the consumption for any and all outlets at a future date and time. Factors such as: the forecast for rain or actual rain on the day or; the forecast of sunshine on the day or hot conditions being greater than forecast; the forecast for windy conditions on the day and the actual wind on the day; certain players/entertainers playing/entertaining or not; the visiting teams; the time of day or evening of the event or game, all influence not only the total attendance but may also influence which outlets will have patronage before, during and after the event or game. The provider is constantly revising estimates, adjusting supply of products, beverages and even staff to best match anticipated and actual demand. Even to the extent of allowing for long queues as long as the service staff persons are being kept busy all the time so as to maximise their return on cost.

There are food and beverage supply systems which accept orders from patrons (who have to pay for their order by credit card at the time or by using an authorised stored card detail) and direct those orders to the appropriate outlet on receipt of which the outlet prepares the order ready for pick-up by the patron. However, that means that the patron who is in line early before completion of the order still needs to wait or worse the patron is not clear as to where the pick-up location is, and does not arrive or arrives much later than they intended. Any lateness on the part of the patron means the patron that arrives well after the order prepared for pickup will need to accept that hot and cold food and beverage they ordered is not provided at an acceptable temperature. Furthermore, when there is pre-payment for the products, there is little or no flexibility for the patron to dispute or change the order.

Thus overall, there are issues relating to the described systems which tend to disadvantage the patron or the service provider, but most times more so the patron. Additionally, with all systems there can easily be 20 or more orders prepared and waiting at one time, the process to find the patron's specific order is often time-consuming, and error prone. Of course once a patron receives food and beverage different in any way from what was ordered, the problem of matching the order, adjust the cost if any need to do so, delays and disputes cascade and ultimately use up the time of the serving staff and prevent other sales. The bottom line effect of any disadvantage is less sales and higher that required costs and that will affect profits.

Yet further there are systems which take orders from patrons in their seat wishing to obtain products from a selected outlet, and once the patrons' order is ready, the prepared order is taken to the patron's seat. This approach is much more expensive for the outlet, due to the added expense of the waiting staff, but the service factor and typically higher cost of those products may justify the added cost to the outlet. In any event, increased costs are charged to the patron one way or another. There will however be periods during which waiting staff are not busy and other periods when waiting staff are too busy and deliveries become delayed. Unless a patron agrees to pay for the products before delivery, it can also be difficult to collect payment. That may be the case unless portable credit and debit equipment are available to each of the waiting staff, even so, there is significant risk that the patron is unable to be located or the order is changed or no longer required, whereupon the order cannot be resold and is wasted, the reason that most orders are pre-paid and that lessens the risks for the outlet. Additionally, portable credit and debit equipment is much more expensive to purchase and maintain than the counter bound credit and debit equipment. Another payment alternative is the acceptance of cash by the waiting staff, but that is not only a security risk for the waiting staff since they must also carry an adequate float and they may not be able to easily reduce their holdings during the serving period.

A further frustration for patrons and waiting staff is when the waiting staff delivers the order to an empty seat, so the order needs to be returned to the kitchen or preparation area and the ordered food and sometime beverage is either wasted (or another delivery attempt is made later). Initial and return deliveries to where the patron is meant to be can be thwarted when the patron that is to pay for the order has left their seat and may be nearby but does not notice the arrival of their order or has left the area temporarily. The outcome can be a wasted order, a need to return or monitor the seat by waiting staff Then upon the return of the patron to their seat who then enquires, as to where their order, only to be advised that it was delivered while they were absent, by which time the order may need to be recreated.

Yet further it may be possible to run a tab arrangement so the patron pays for everything well after the orders have been fulfilled and presumably appropriately and timely delivered. For all of the payment arrangements described each payment takes a finite time and includes the actions of the patron and the wait staff, and complications such as non-delivery of ordered products, products delivered not as ordered, and disputes about the quantity and quality of the products and service, and locating the person to pay the tab. Most systems involve the patron needing to wait in line at a charging station. Again it is clear that most systems tend to disadvantage the patron and at times the service provider and in particular their staff

There are other variants to the previously broadly described systems. Some of which involve much more automated ordering systems and involve payment arrangements that use the convenience of the patron's mobile computer device, or pre-stored and authorised credit card details rather than portable Electronic Funds Transfer Point of Sale (EFTPOS) devices. Sometimes the patron my change their mind about the order contents, or a patron's friend may wish to pay. Where mobile phone ordering exists most systems debit the payment as soon as the order is made, but that does not allow for changes to the order or an easy way for the patron to complain about the quality or quantity of the ordered food and beverage. Sometimes it is inevitable that the patron has to line-up at two different outlets, and that means the time devoted to payment is doubled for the patron as it is also for the service provider but that is likely in any system since the venue rarely provides all food and beverages from every outlet.

Some systems attempt to organise the arrival time of the patron at the one or more outlets and provide fulfilment windows by asking them to turn up at a specific time so that the fulfilment processes is most likely to have been completed and during busy time the system throttles the demand by advising the patron that their order will be ready for pick-up in 20 minutes time, or ten minutes time so as to delay multiple patrons arriving at the outlet all at the same time. Those systems work to suit the outlet and not the patron, but mostly there are complications due to late or early arrival, or no arrival or the wrong order being received, especially since the patron has ordered and paid for their order to be fulfilled. Therefore such systems are not always responsive enough to deal with the patron being quicker than was requested to arrive at the outlet, or much later than requested, or certainly do not deal well with the waste of an order when a patron does not turn up to take delivery of the fulfilled order, and due to the commitment made by the patron they will be liable to pay for their order whether they pick it up or not with the outlet likely not to reallocate the product/s since the patron has paid for them.

Current systems work within the confines of venue ordering, fulfilment and payment components, and the faster each component performs, the less human intervention and the greater the throughput of patrons and stock (food and beverage), the greater the profits and lower the complications. Not unsurprisingly, the humans that are in the main involved in fulfilment and payment tasks are under great pressure to perform quickly and faultlessly every task allotted to them, including resolving complex disputes that arise all too often.

Furthermore, the fulfilment tasks performed by humans can only happen if there is sufficient current stock of each food and beverage ordered from that outlet. There are systems devoted to maximising the likelihood that sufficient stock is on hand to satisfy the expected orders. Each outlet can have a long and detailed history, and over time provisioning can become accurate enough to satisfy most situations. However, this approach is very service provider-centric and subject to many variables just like those described above in relation to prediction of the required foods and beverages to order before an event or game at the venue. Although overtly the described approach helps to satisfy patrons, the ultimate goal is to minimise wastage of resources such as food, and over or underutilisation of staff. It is also of benefit to the provider to minimise the use of energy to prepare and maintain the food and beverage at optimum serving temperature, and minimise labour involvement, all of which when optimised most benefit the provider and maximises profit.

Further if the sports match or another event with a known completion time finishes early or unexpectedly, including for external factors such as a power outage, medical event, climate event or some other emergency, the unfulfilled but prepaid orders cause significant disruption and angst for the patrons as there is a made scramble for hundreds, sometimes thousands of patrons to ensure the appropriate refund for their unfulfilled orders before they leave, wait on the phone or follow-up in the following days.

In the previous discussion, certain articles and methods are described for background and introductory purposes to highlight existing limitations and problems. Nothing contained herein is to be construed as an admission that the background described is prior art. Applicant expressly reserves the right to demonstrate, where appropriate, that the articles and methods referenced herein do not constitute prior art under the applicable statutory provisions.

### BRIEF DESCRIPTION OF ASPECTS DISCLOSED HEREIN

This Summary introduces a selection of concepts in a simplified form that is further described below in the Detailed Description. This Summary does not identify key or essential features of the claimed subject matter, nor is it intended to be used to limit the scope of the claimed subject matter. Other features, details, utilities, and advantages of the claimed subject matter will be apparent from the following written Detailed Description, including those aspects illustrated in the accompanying drawings and defined in the appended claims.

The objective problem to be solved is when and where (at which outlet) to prepare an order for fulfilment of one or more products if the patron that created the order is not obliged to have their order fulfilled, wherein a technical aspect of that circumstance is how to determine and set the likelihood that the patron will attend a particular outlet and thus determine a time when to begin to prepare the patron's order based on the location of the outlet and the location of a device in the possession of the patron, and further to ensure that once the order is fulfilled and confirmed to have been fulfilled there is a device to facilitate purchase of the order, since until that action the intent to purchase is exactly that, an intent and not a commitment. Advantages of the solution to that problem include time and product saved by the supplier of the product/s, the ability to aggregate orders and pre-prepare orders with a high-likelihood that they will be fulfilled, and the ability to replicate the system and method for many patrons and multiple outlets, thus multiplying the savings in time and product and creating conditions that permit greater sales compared to traditional product sales through outlets recognising that all the gains obtained arise directly from the notion that there is only an intention to purchase.

Disclosed in an aspect is food and beverage product provisioning system to enable a patron to use a mobile computer device application to create and communicate an order for one or more products or services available from any of one or more outlets they intend to purchase. The system comprises: a back-end computer server adapted to receive the communicated order from the patron and dynamically adjust the time and outlet location prediction of the pick-up of the order based on patron behaviour after the patrons order is received. The system further comprises at least one order display device being located at each outlet, configured to receive information representative of a) an order for product or services; b) the patron associated with the order; c) a indictor to commence the preparation of the order at the time of receipt of the information or at a future time, wherein the fulfilment of the order or lack of fulfilment of the order is at least one aspect of that patrons behaviour used in the time and outlet location prediction of the pick-up of the order.

In an aspect, there is a food and beverage product provisioning system which enables a patron to use a mobile computer device application for which the patron has previously registered to submit a selection of one or more products they intend to purchase wherein the patron may pick up the products they indicated an intention to purchase from any outlet which can fulfil the provision of the one or more selected products and wherein the patron may change the order associated with their intention to purchase at before purchase, and they may choose not to pick up their order since it was only ever an intention to purchase. The system comprising: a back-end computer server configured to associate the mobile computer device with a received intention to purchase an order for one or more products; a first proximity determination device providing a trigger when the patron having the mobile computer device in their possession is located at a first predetermined location associated with an outlet and is adapted to detect the proximity of the patron's mobile computer device to the predetermined wherein the first proximity determination device and the back-end computer server are adapted to send and receive a notification between each other that a patron having an intention to purchase is within proximity of an outlet; a second proximity determination device provides a trigger when the mobile computer device is located at a second predetermined location associated with the outlet wherein the second proximity determination is communicated to the back-end computer server system, and an order display and fulfilment device associated with the second proximity determination device is adapted to display data; wherein the second proximity determination device is adapted to send and receive notification that the mobile computer device associated with the patron having an intention to purchase is within proximity of the second predetermined location and the back-end computer server provides data to the order display and fulfilment device to display, to an operator at the second predetermined location, that the patron is present and has an order to be fulfilled and wherein the patron has indicated their intent to purchase the ordered products, the operator at the second predetermined location by interacting with the order display and fulfilment device which is adapted to receive an input that confirms that the order matches the products in the possession of the patron and effects payment for the products.

Disclosed in an aspect is a food and beverage product provisioning system to enable a patron to use a mobile computer device application for which the patron has previously registered to submit a selection of one or more products they intend to purchase, whereby the patron may pick-up the one or more products they indicated an intention to purchase from any outlets which can fulfil the provision of the one or more products, wherein the patron may change their intention to purchase prior to purchase, and they may choose not to pick up their order since it was only an intention to purchase. The system comprises a back-end computer server configured to associate the mobile computer device with a received intention to purchase an order for one or more products from an outlet; at least one order display device located at each outlet adapted to display data at least relating to received orders; a first proximity determination device providing a trigger when the patron having the mobile computer device in their possession is located at a first predetermined location associated with an outlet and is adapted to detect the proximity of the patron's mobile computer device to the predetermined location wherein the first proximity determination device and the back-end computer server are adapted to send and receive a notification between each other that a patron having an intention to purchase is within proximity of an outlet wherein the back-end computer server then provides data to the order display device at the outlet in proximity to the first proximity sensor to alert an operator at the outlet of the order which the patron indicated as being intended to be purchased so that the order can be fulfilled; and a second proximity determination device provides a trigger when the mobile computer device is located at a second predetermined location associated with the first outlet wherein the second proximity determination is communicated to the back-end computer server system that the mobile computer device of the patron associated with an intention to purchase is in proximity to a second predetermined location of the outlet and the back-end computer server then provides data to a predetermined order display device to alert an operator data representative of the order which was intended to be purchased by the patron for checking and that that order is confirmed as being picked up by the patron; wherein the order is purchased by the patron authorising the relevant charge by interacting with the mobile computer device application which is adapted to send that authorisation to the order display device and then to the back-end computer server.

Since the patron indicated their intent to purchase those products and they have not yet done so a back-end computer server can authorise the charge for those products by interacting with the order display and fulfilment device and displaying that action for viewing by the patron.

In an aspect, the order can be purchased by the patron authorising the relevant charge by interacting with the mobile computer device application which is adapted to send that authorisation to the back-end computer server using the order display device or the second proximity determination device.

In an aspect, the first predetermined location is the predetermined entrance or near the predetermined entrance to an outlet or predetermined queue at the outlet.

In an aspect, the second predetermined location is the exit or near the predetermined exit of the outlet or the beginning or intermediate the ends of a predetermined queue located at the outlet.

In an aspect, the back-end computer server is adapted to dynamically adjust the time and location prediction of the pick-up of the order based on patron behaviour after the patron orders product indicating an intention to purchase that order. A back-end system uses various metrics including past behaviour of the patron and/or similar patrons (including the likelihood that the patron will not pick-up their order), as well as the geo-location of the patron, to predict where and when the patron is likely to pick up or receive the order that they have placed as an intention to purchase. The back-end system can dynamically adjust the time and location prediction of the pick-up of the order based on patron behaviour after the intention to purchase step and accommodate for the order being picked up or not being picked up and an example of that dynamic feature is the ability for the back-end system to record and include past patron behaviour, examples of which include whether the patron has placed and order and then not had that order fulfilled, the transit time of the patron, the outlet or outlets patron has picked-up from. Using the collective and consolidated real-time intent to purchase patron data and predicted demand for each outlet including estimated pick-up time, venue management and outlet supervisors are able to make decisions on labour, product preparation quantities and stock levels to optimise work-effort and minimise wastage as well as reducing patron pickup wait times and warning patrons in advance if particular outlets are busy or running low on stock

Importantly there is no obligation on the patron to acquire/pick-up the products and the patron is not charged for their intended order until the order is picked-up/collected/fulfilled and it only because of this principle that the prediction system works as well as it does while offering the type of convenience to the patron they do not have with present systems.

Confirmation of the completion of the transaction can be provided to the patron by the back-end computer system using one or more information exchange mechanisms.

The reference to any prior art or ways of providing fast food and beverage product in this specification is not, and is not to be assumed to be an acknowledgement or any form of suggestion that such prior art forms part of the common general knowledge.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

It will be appreciated that various modifications can be made without departing from the principles disclosed. Therefore, the embodiments should be understood to include all such modifications within their scope.

### BRIEF DESCRIPTION OF THE FIGURES

FIG. 1 depicts an embodiment of system parts of which are adapted to provide an intention to purchase application useable by a patron on their mobile computing device which is adapted to interact with the patron and a back-end computer server which is adapted to interact with one or more input and display devices located at an outlet and a payment system;

FIG. 2 depicts an embodiment of a patron entering data into a user interface on a mobile computer device;

FIG. 3 depicts an embodiment of a patron entering an intention to order into a user interface on a mobile computer device;

FIG. 4 depicts an embodiment of at least one outlet from which to pick up an order following the placement of an intention to purchase and at which payment can be authorised upon fulfilment of the order;

FIG. 5 depicts an embodiment of a flow diagram of an intention to order process; and

FIG. 6 depicts a generalised version of a machine learning approach suitable for the task of determining the likelihood of a patron attending a particular outlet to fulfil an order for product that patron made but did not commit to pick-up the order and thus fulfil the order.

### DESCRIPTION OF EMBODIMENTS

As used in the specification and claims, the singular form “a”, “an” and “the” and include plural references unless the context dictates otherwise.

The present disclosure may use the term “comprise” (open-ended) or “consist essentially of” the components of the present disclosure as well as other methods or elements described herein. As used herein, “comprising” means the elements recited, or their equivalent in structure or function, plus any other element or elements which are not recited. The terms “having” and “including” are also to be construed as open-ended unless the context suggests otherwise. As used herein, “consisting essentially of” means that the claimed arrangement, method and system may include elements in addition to those recited in the claim, but only if the additional elements do not materially alter the novel characteristics as claimed.

Where used herein, the term “and/or” when used in a list of two or more items means that any one of the listed characteristics can be present, or any combination of two or more of the listed characteristics can be present. For example, if a step is described as containing characteristics A, B, and C, the step can contain A feature alone; B alone; C alone; A and B in combination; A and C in combination; B and C in combination; or A, B, and C in combination.

The following disclosure includes many scenarios, and not all are related to each other.

In an aspect the food and beverage product provisioning system enables a mobile computer device to be used by the user to use or access either a downloadable application or a browser based application or any similarly functioning arrangement (herein referred to as an application) to create an order for products that the user does not have to pick up if they change their mind or are not able to do so, and not be charged for the service or the order not fulfilled.

To facilitate that functionality, the mobile computer device will have a location determination mechanism which can be polled or provides at a predetermined rate a location update of the mobile computer device. That type of functionality is available in most mobile computer devices that are also equipped to provide a data and telephony service to the user.

The mobile computer device is configured to execute a downloadable or on-line application and wherein the mobile user can register as a patron of the application so they can use the application to place orders for products and services The mobile computer device application associates the registered user of that mobile computer device application with a unique identifier which is unique to that patron. The application is configured and equipped to communicate a location update only made available from the location mechanism of the mobile computer device when the application is in use. The mobile computer device is adapted to accept from a user of the mobile computing device a created order for a selection of one or more products.

It is accepted that the patron will only pay for the ordered products or service (or any amendment to the created order), after the order is fulfilled. The patron or a trusted person will in anticipation of their order being ready attend with the mobile computer device at any of the outlets from which the products ordered can be provided. Indeed the ability of a trusted person to act on behalf of the patron only happens if that trusted person is trusted to have possession of the mobile computer device that was used to create the order, and also trusted enough in one embodiment to have access to the functions of the mobile computer device.

Fulfilment is the act of the patron or a trusted person receiving/taking possession of the products listed in the created order (as it exists at the time of receipt) while in possession of the mobile computing device. It is, in an embodiment, possible for the patron to authorise another person to take possession of the mobile computer device and to have that authorisation made known to the back-end server so when it communicates to the appropriate outlet it can include information about that authorisation. By way of example, when and if an image of the patron accompanies the information sent from the back-end server to the outlet the image can be annotated to indicate that someone else will be picking up the order. The annotation may also authorise the person then in possession of the mobile computer device to make changes to the order or to add or delete to the order. It should be noted that for some products such as alcoholic beverages, the person with possession of the mobile device must meet local eligibility requirements (age, sober, etc.) to allow for that order to be fulfilled.

The act of possession becomes the point in the transaction that changes the patron's intention to purchase into a commitment to purchase. There will be some legal dispute about the whether it is the payment by the patron or the authorisation to perform the payment by the patron that is the actual point at which the intention to purchase changes because at that point there is satisfaction of an implied contract between the patron and the supplier for transfer of ownership of the goods for the agreed price. It does matter though that principle of the arrangement disclosed herein applies during all the processes described and that allows and provides for maximum flexibility in the behaviour of the patron, and for the supplier to accommodate that flexibility using the method and apparatus disclosed herein in a manner which allows for there to be uncertainty as to whether an order will or will not be fulfilled.

In the embodiment disclosed fulfilment is achieved by receipt of the product or products by the relevant person in possession of the mobile computer device. Notably, whereby the user/patron may pick-up the one or more products of the created order from any outlet which can fulfil the provision of the one or more products. Wherein, it is possible for the patron to change their intention to purchase prior to the fulfilment of the created order. Wherein, it is allowable for the patron to choose not to pick up their order since it was only an intention to purchase the created order. Wherein, it is possible for the patron that normally goes to a particular outlet to choose to go to any of the other outlets which can fulfil the provision of the one or more products or provide an ordered service. This latter situation may occur when the patron is invited to sit beside someone and that means that the patron is not in their normal seat, or if the patron agrees to meet a friend at the outlet nearest the friend's seat. All the while the back-end server determines the likelihood of the mobile computing device and the user of the mobile computing device attending a particular outlet and at what time that is likely to occur.

In one example scenario, a person is seated at a large sports venue, and before that time, that person has downloaded a predetermined software program (typically referred to as an application or app as a shortening of the term) onto their mobile computer device. A mobile computer device is typically referred to as a mobile phone or cell phone since in most cases a telephony and data communication service is accessible from and available to the mobile phone but not all mobile devices have a dedicated telephony function. For example a tablet computer or a portable computer does not have a dedicated telephony service. However, it is possible for tablet computers (including iPads (Trade Mark of Apple Inc.) or portable computer devices to have a data communication capability. In some cases that data communication service is provided by a cellular telephony service provider, since the communication services they provide communicate both telephony and data. Therefore, the more general term mobile computer device is used herein.

A mobile computer device has many other functions, for example, an easy to use user interface (UI) to assist the user to access the myriad of functions and applications included and downloadable or usable and available on-line to the mobile computer device, data processing capability, video and image processing and display, audio processing, database management, an internet browser, modem/s for interconnection to one or more communication mechanisms and technologies, control of sensors which input and output various signals and actuations and if not a touch activated screen for displaying information and also receiving touch/swipe and other haptic inputs. All the functionality of a device is controlled by a computer or multiple computers and associated memory within the device. In the case of a mobile phone device there is a data communication capability comparable to the data communications described earlier in relation to the tablet and portable computer devices and that includes one of multiple data paths to one or more remote back-end computer servers using an appropriate protocol, such as Internet Protocol.

An application (computer executable program) downloaded by the mobile computer device can be made available by one or more sources such as by way of example only, an application store typically controlled by the creator/developer of the operating system of the mobile computer device, but may in some circumstances be made available by the creator of the application from their own server/s. The application is maintained by the creator/developer, and as will become clearer the data made available by the application to the user of the application is also made available and updated so as to ensure that the data/information of use to the user of the application is current.

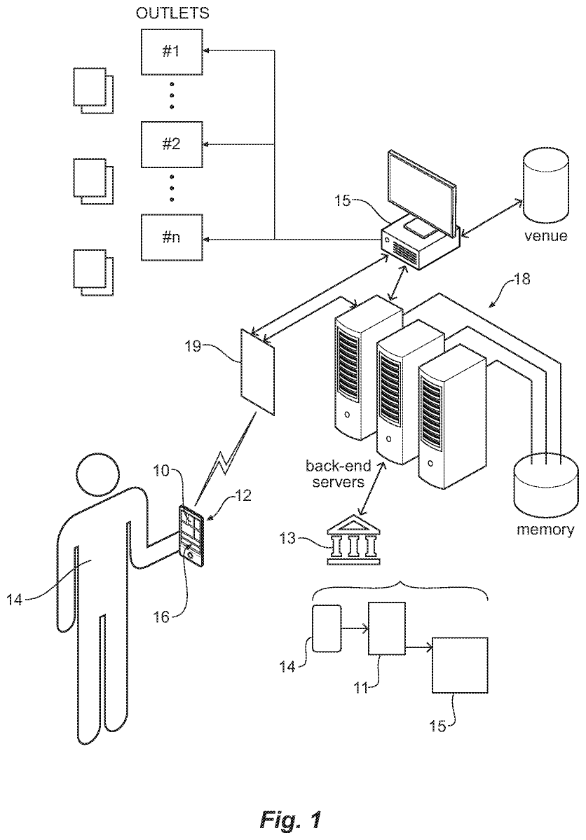

Referring to FIG. 1, the application 10, once installed (see FIG. 1) on the mobile computer device 12, is executable and uses the memory and the processor of the mobile computer device to allow the user to register and thus become a patron 14 of the one or more service providers 15 (FIG. 1) such as a catering service responsible for operating one or more outlets #1, #2, . . . ,#n as depicted in FIG. 1. Typically, the catering service is an integral part of the stadium, theatre or event centre, so the number and location of all outlets are known for each venue. However, the downloaded application is adapted to service the needs of multiple venues which operate independently of each other or may even be part of a larger organisation. The application provides to the user a selection of venues that will offer product for ordering and it is that selection that is a precursor for the method described in detail herein.

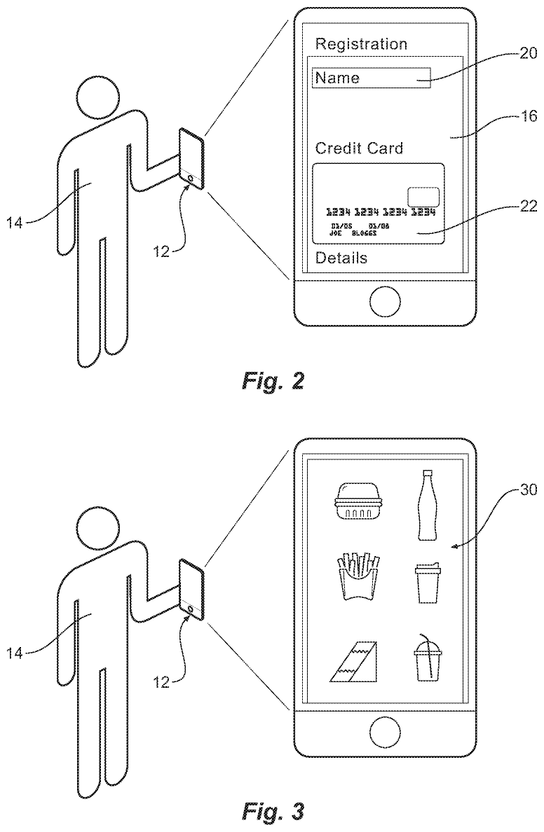

The user of the mobile computer device provides information using the application's mobile computer user interface 16 of the mobile computer device (FIG. 1). The user interface is controlled by the application (and may be specific to the operating system of the mobile computer device) and is arranged to provide prompts to the user, by way of example, visual, sometimes audible and other forms of prompts and interactive symbols arrayed on the visual output of the mobile computer device, to guide the user to enter various data using the available input mechanisms, which can be specific buttons and text (pre-set and free form), or audio spoken by the user, during the user registration process, an example is a users' full name 20 as depicted in an embodiment illustrated in FIG. 2.

It can be optional for the user to opt-in to provide one or more further data. However, the user can choose to provide or even opt-out later or just not provide further information at the registration stage, or decide to allow or not allow access of the application to certain functionality of the mobile computer devices. Examples of that type of one functionality that will be required is location determination using location updates (LUs) provided to the mobile computer device from an internal mechanism. LUs can be provided by the mobile computer device regularly (say every second) or the LU can be polled. A polling process is controlled by the downloaded app and then provided to the back-end server 18 at the same rate, or polled (requested when the back-end computer server requires an LU).

LUs can be provided by many types of location determination mechanisms available on the mobile computer device. One example is the use of the Global Positioning System mechanism (which may be one or a combination of Satellite location determination techniques managed by a dedicated chip in the mobile computer device), or any of the other GPS like systems and a respective chip. Those alternative systems with their respective enhancement and limitations include: NaviC, GLONASS, BeiDou, Galileo and Quasi-Zenith. Other examples of location determination mechanisms include: Cell Tower Triangulation using the mobile communication supplier to the mobile computer device; WiFi base station identification as provided by the known locations of received base stations or determined from a triangulation process using three or more received base stations, etc.); Bluetooth communications (including one or more modes: Low Power Bluetooth mode; Standard Power Bluetooth mode) from beacons and the like; Near Field Communications (NFC) from beacons and the like; and a simple but user initiated location prompt the reading of a 2-dimensional code by a reader application that interacts with the downloaded app and which includes the exact location of the place at which the code is read.

The use of satellite based location determination mechanisms can be advantageous since the determination also includes an altitude value and although the altitude values is not as accurate as the longitude and latitude determinations, the altitude value can be useful and can assist the application to make a better determination of the distance between a patron and an outlet, since local knowledge can be used to indicate that transit distances will include a flight or flights of stairs and thus direct distance can be misleading as to proximity, and further when time of arrival to the entrance to an outlet will be affected by the existence of stairs or lifts, especially for mobility challenged patrons.

All the mentioned position determination mechanisms have various accuracy and reliability parameters and characteristics, so it is not unusual for there to be a further mechanism to create a fusion of the various mechanisms available to the mobile computer device to provide an LU to the mobile computer device and the various applications thereon.

Importantly, it is known that not all the location determination mechanisms work everywhere. Thus, it is known that GPS does not always provide an accurate LU when the GPS receiver chip (in a mobile computer device) is located inside a building or a venue which is made of vast volumes of concrete and steel structural members. In such environments beacons and other types of location determination infrastructure is installed. Therefore, it is important that the mobile computer device have a range of location determination mechanisms and that it is a bonus when those that are working within an acceptable level of accuracy are fused or a hybrid approach is taken, so that the best available location determination can be selected and thus provided as the LU at the time or at predetermined intervals. The use of hybrid technologies provides position determination despite the occasional unreliability of one or more of the mechanisms available to the mobile computer device in different environmental and physical locations.

A location is generally expressed using the WGS (world geodetic system) 84 standard which is used for expressing locations. The following are location determination quantification standards ED50, ETRS89, GRS 80, NAD 83, DAVD88, SAD69, SRID and UTM that do not fall under WGS 84. Standards ensure that GPS data will be accepted by users of that GPS data as is the case for most mobile phones. As is the case in all real world electronic and communications systems there is error which needs to be accounted for and consequently accuracy can be adversely affected. GPS error analysis examines the sources of errors in GPS results and the expected size of those errors. GPS makes corrections for receiver clock errors and other effects but there are still residual errors which are not always corrected. Sources of error include signal arrival time measurements, numerical calculations, atmospheric effects, ephemeris and clock data, multipath signals, and natural and artificial interference. The magnitude of the residual errors resulting from these sources is dependent on geometric dilution of precision. Thus when the term “location determination” is used the actual manner in which a location is presented is wholly dependent on the location determination technique used to determine that location and that there will be a known accuracy of determination which itself may be dependent on the application of the respective technique to the circumstances of the determination and which may be applicable to the determination only at the time of the determination and updated with future determinations.

The most widely used position location technique is that generated from a GPS receiver and the GPS data generated can be made available (sometimes for display) in different message formats to a mobile computer device. There are standard and non-standard (proprietary) message formats. Nearly all GPS receivers output NMEA data. NMEA 0183 is a currently used format, as of the writing of this specification, combined electrical and data specification for communication between marine electronics devices such as echo sounder, sonars, anemometer, gyrocompass, autopilot, GPS receivers and many other types of instruments. The NMEA standard is formatted in lines of data called sentences. Each sentence contains various bits of data organized in comma delimited format (i.e. data is separated by commas). An example NMEA sentence from a GPS receiver with satellite lock is provided below (4+ satellites, accurate position).

An example the GPGGA sentence follows:
COPY CODE$GPRMC,223316.000,A,34.9285,S,138.6007,E,0.09,144.75,141112,,*19
$GPGGA,223316.000, 34.9285,S, 138.6007,E,1,08,57.9,M,−20.7,M,,0000*5F
$GPGSA,A,3,22,18,21,06,03,09,24,15,,,,,2.5,1.6,1.9*3E
Wherein, the GPGGA sentence contains the following information:
Time: 235317.000 is 22:33 hours/minutes and 16.000 seconds in Greenwich meantime
Latitude: 34.9285,S is latitude in degrees. decimal minutes, South
Longitude: 138.6007,E is longitude in degrees. decimal minutes, East
Number of satellites seen: 08
Altitude: 57 meters.
The data is separated by commas to make it easier to read and parse (read and separate the data) by computers and microcontrollers. This data can be sent out of the GPS chip or circuit on a serial port at an interval called the update rate. Most GPS receivers update this information once per second (1 Hz), but more advanced receivers are capable of generating multiple updates per second at 5 to 20 Hz are possible. It is the Latitude and Longitude, and if the calculation accommodates it, the altitude information, which is used in the general method described.

The location update provided by a determination mechanism can in an embodiment be provided using the NMEA standard or some other output which is usable by the application and the back-end server.

At least one location determination mechanism that provides mobile computer device location determination or allows interaction with a proximity sensor to make a location determination is required in the system disclosed in this document.

The back-end server will collect location data during the time the application is in use and the patron will have been advised accordingly and have been asked to agree to that collection since not only will the patron's location be collected at each LU, there may be calculations conducted on the fly as each LU is received. There may also determinations based on historical LU data, from which it is possible to do and not be limited to: calculating the current speed of travel (typically walking), the average travel speed over all records (from the patrons seat to the nearest outlet over multiple trips, or from a regular parking spot to the outlet they regularly attend before the event, etc.); and all the trips the patron takes from their seat to one or more outlets in one or more venues since such data can be used to improve the determination of the likelihood that the patron will arrive at a particular outlet at a particular time, knowing only the location of that patron at a particular time. A further embodiment involves calculating the distance travelled by the patron using dead-reckoning when all other location determinations are not available, temporarily or for an extended period as can be the case deep within a sports venue or under a large building.

Thus the system comprises a back-end computer server adapted to receive the order from the patron and dynamically adjust the time and location prediction of the pick-up of the order based on patron behaviour after the patrons order is received. As described the patron behaviour is not only their mobility history but can also include: the location, event, time of day and whether the patron did not pick-up an order; the outlets at which the patron picks up orders and the number of times they have done that for each outlet; the orders the patron has provided; the orders and changes to those orders and the number of times that changes have been made; the venues at which the patron attends and uses the application to order and fulfil that order; and myriad of other details that can be stored by the back-end server during the use of the application.

The mobile computer device and the subject application will also need to be permitted to access a payment functionality using one or more mobile computer device arrangements. The user may manually provide details of Credit Card, Debit Card, mobile phone wallet services, such as ApplePay™ of Apple Inc, GooglePay™ of Alphabet Inc, to facilitate prior authority 22 (FIG. 2), and possibly others due to the many arrangements currently available and yet to be made available to permit payment at the time of fulfilment of the order.

The application 10 and the API 19 (FIG. 1) executed by the back-end computer server 18 will use each of the data provided by the patron 14 during their use of the predetermined application to increase the usefulness of that application to the patron, and thus ultimately allow the more timely provision by the service provider 15 of ordered product to the then patron. It is possible to provide a service with as little information as the name of the user and knowing where they are after they created an order. That is not ideal if additional services that are more suited to the patron are to be made available, but, it is completely up to the patron and user of the mobile computer device to decide the type and amount of additional data they are willing to provide.

The downloadable or on-line application is designed to provide for a variety of service providers 15, 15′, 15″ as will be described in this disclosure. However, there is a creator/developer 11 of the application and the various functions included in the application executing on the mobile computer device are managed and can be controlled by software executing on a back-end computer server 18. So by way of example, the creator/developer can be the go between for financial transactions using the payment gateway and payment institutions 13, and in one embodiment assume the risk of non-payment by a registered patron, such as might occur when there is a Credit Card default (normally a validity period issue and occasionally fraud, both of which do and have a high potential to divert valuable outlet staff time and sometimes the management staff of the stadium or event venue to resolve). Thus the creator/developer can in an embodiment, ensure payment is made to the supplier of the products and services offered using the application, although there may be service charge for doing so. In another example relating to financial transactions, the service provider 15 can directly upload data via a data gateway 18′ (not shown as it is typically a software module executing on the back-end computer server or an associated server) and a service provider specific Application Program Interface (API) to the back-end computer server.

The types of functionality provided by the back-end server include storage of temporary and long term data, database management for recordal of patron personal/private data (such as identifying data and Credit Card tokens (so as to avoid having that type of data on file), creation or identification of a unique identifier for the patron and the mobile computer device being used, and computing power to service the data communications between the back-end server multiple applications executing on respective mobile computing devices, as well as the one or more individual computer devices located at each outlet being in an embodiment, at least one order display device located at each outlet that can fulfil the provision of one or more products. The order display device is configured to receive information representative of a) an order for product or products; b) the patron associated with the order; c) an indictor to commence the preparation of the order at the time of receipt, or to commence the preparation at a future time.

In an example, data uploaded to the back-end server from the outlet relates to each product and service, potentially including an image and product related text and possibly even audio/visual type files presenting promotional material about the venue and product and services on offer or particular products and services, as well as the related cost. All that information is served to the application from the back-end server and thereby is also arranged to indicate which outlets within the venue the patron my wish to visit to fulfil their order. Examples of that type of data include: staple products and services (such as for example hotdogs/concessions/beverages) or one-off and special foods, beverages and associated services. FIG. 1 depicts only one service provider 15 but the structure described is repeated for each of other 15′, 15″, . . . service providers (not shown).

Thus the service provider 15 will make available the selection of a variety of products (such as food and beverage product) to the back-end server which is passed on to the mobile computer device used by a patron 14. The selections and the format of those selections are presented on the screen of the mobile computer device tailored by the application or the back-end server. The patron can indicate using the UI of the application 10 which items and at what quantity of each product that they have an intention to purchase from the service provider. At this stage the service provide cannot be sure that the patron will actually attend an outlet to fulfil the order so no payment is transacted, and no payment reserved even though the patron's banking or credit details are available.

In an embodiment, the creator/developer 11 of the application acts as an intermediary for all transactions. The function of the intermediary can be very useful to the provider of the products and service. It is possible for the intermediary to ensure the validity of each financial transaction, ensure that credit card fraud and declines for a particular transaction are dealt with thus reducing or eliminating an issue that creates loss of time and patron displeasure with the supplier.

In an aspect the manner in which the result of a transaction is to pay for an order which may or may not be fulfilled (intention to pay), where there is no need for the order to be associated with any particular outlet of many from which to pick up that order. This arrangement relies on at least the specific element of a location determination mechanism that specifically provides an acceptably accurate first determination of the location of the mobile computer device of a patron that has ordered products even though they have not committed to pick-up that order. In particular when the mobile computer device is determined by the location determination mechanism to be at a predetermined location from an outlet (being one of one or more) there is an indication that the patron is in the vicinity of an outlet from which the patron may pick-up their order.

There is at least one order display device 400 located at each outlet #n which is configured to receive information from the back-end server representative of a) an order for product or products; b) the patron associated with the order; c) a indictor to commence the preparation of the order at the time of receipt of the order or at a future determined time.

The order, as communicated from the patron's mobile computer device to the back-end computer server 18, is displayed on an order display device 400 located at the outlet once that patron has been determined (the method of determination as yet to be described) to be in the vicinity of the outlet such that there is a predetermined likelihood that the patron will present at that outlet. The order can then be made available from that outlet but the patron will still be without compunction if they do not present themselves and the mobile computer device at any of the outlets to have the order fulfilled. The outlet will however still make up the order and should the patron not arrive at that outlet as predicted by the back-end server, then that order will likely be used by another patron and the time devoted to the task will likely not be wasted. Furthermore, it is also likely that the convenience provided to patrons will make it more likely that they will present to have their orders fulfilled and a no show will be a rare exception. It may be that the patron was called away on compassionate grounds and although they had a genuine intention to purchase they were not able to present to do so, or the patron returns to the event to see the action not worrying about taking a spot in a line and waiting to be served if they did not use the disclosed arrangement. The patron will not be charged for their order and they will appreciate the additional convenience of such a system and be oblivious to the actions at the outlet and the determinations being made on a repeated basis by the back-end server in anticipation of the patron's arrival at an outlet.

The supplier will very likely not be unduly concerned, if the outlet did prepare an order that was not picked-up, since built into the efficiencies the system is providing for hundreds if not thousands of orders to patron allows there to be some level of loss, if the order does become wasted. The outlet and provider will have many times previously gained time savings in food and beverage sever time, stock control, minimises time consuming payment disputes and increased patron satisfaction with the food and beverage provisioning system. Yet further, there are embodiments where even more food and beverage server time can be saved, as the back-end server system aggregates orders that are likely to be picked-up at much the same time and comprise the same or very similar product. By way of example, a server can pour eight beers of the same type and await the patron wanting three beers, the next patron wanting four beers and the next patron wanting only one beer and promptly serve them without having to individually pour each beverage order. Yet further in an embodiment, there will be a time saving for the food and beverage server allocated to collect payments locates at the exit of the outlet. Thus, when interacting with a patron in possession of their ordered product/s the server is required to check that the order (all the products) that patron made are in their possession and are the same as that displayed on an order display device.

In an embodiment, the patron in possession of the mobile computer device provides an LU and thus the back-end server is aware that the patron is at the exit to the outlet. The patron has products that are the same as their order in their possession and an image of the products in the patrons possession is obtained and stored by the back-end server. To assist automatic recognition of the products they are arrayed on a provided table or tray, so that an image capture device located at the exit to the outlet can record an image and send it to the back-end server. The back-end server executes a known image recognition process on the received image to identify each product and to match or not match them, to a product in the order.

If there is a match for each product in the possession of the patron then the order is fulfilled. If there is a discrepancy then there are many alternatives available. In one example, if there is one or more products not in the patrons possession then the patron can be altered on the mobile computer device and they can obtain the missing product/s so that the order is complete, the patron may have changed their mind and after confirming they do not want one of more of the ordered product/s the back-end server adjusts the total cost based on the product then in the possession of the patron. In another example, the patron is in possession of one or more products they want to add to the order, and once the patron has been altered on the mobile computer device that there are more products than they ordered then the patron can authorise the additional cost for their order.

In an embodiment, the patron is trusted to have in their possession the same products that they ordered and is permitted to merely pass through the exit of the outlet (that being determined by the LUs provided by the mobile computer device) without a server to manually check the order against the products in the patron's possession. If there is a breach of trust and the patron has more product/s than they ordered, that may be an acceptable risk to the supplier. In an embodiment, an image capture device records an image of the patron with product in their possession. The captured image or images are sent to the back-end server for storage. The taking of that image is initiated by the patron passing through the exit of the outlet, as determined by the LUs provided by the mobile computer device in the possession of the patron. Although in this embodiment all patrons are trusted to exit the outlet with their ordered product/s, each or random or selected captured images stored by the back-end server can be processed by the execution of a known image recognition process to identify each product and to match or not match them, to a product in the order of the respective patron. If there is a discrepancy then the patron can be contacted and provided the relevant captured image and a notice that payment has been made for the additional product/s. Disputes are less likely to occur, but in the case of a failure by the system that dispute will involve a human to human interaction to resolve.

The fulfilment step is followed, in one embodiment, by a simple interaction between the server and the back-end server using a display device to confirm the order has been fulfilled, as well as the effective touch action by the patron using their mobile computer device into suitable proximity to an input device to authorise the payment.

The fulfilment step is followed, in one embodiment, by the location determination of a patron at the exit to a self-service outlet and that situation triggering the back-end server to effect payment for the order, this process being completely reliant on the trustworthiness of the patron.

The fulfilment step is followed, in one embodiment, by the location determination of a patron at the exit to an outlet and that triggering the back-end server to receive authorisation for payment for the order following the effective touch action by the patron using their mobile computer device into suitable proximity to an input device to authorise the payment, this process being completely reliant on the trustworthiness of the patron.

Those seamless payment actions described in the previous paragraphs can be contrasted with the multiple actions of a product and service server collecting each order, handing the order to the patron or observing and possibly scanning each item of the product they are purchasing, then tallying the order on a register which typically has many keys representing the whole range of products on offer, transferring, keying or showing the displayed total monetary amount into a register or EFTPOS machine. Then finally receiving payment which can be made in a variety of ways. Sometimes a tap of a card which the patron has to have at the ready, or they belatedly extract from a pocket, wallet or handbag. Sometimes the transaction may also require a PIN to be entered into the EFTPOS machine to complete the payment transaction, and every action described in this paragraph is additional to the arrangement disclosed herein. Time saved ensures greater throughput of patrons and greater product and services purchased by patrons all of which benefit to the supplier.

In an embodiment there is the specific provision of a second determination of the location of the mobile computer device of a patron who has ordered products that is a predetermined location (within error boundaries) or a predetermined geographic line or geographic region (within error boundaries and also referred to as a predetermined location herein) which is determined by the mobile computer device, in which case the mobile computer device reports to the back-end server that is at the predetermined location. In an embodiment that determination could be as a result of an LU provided by the mobile computer device or by the bringing of the mobile computer device into proximity with the display device, which then may use a communication mechanism such as BLE, Bluetooth, NFC or even a very specific beacon to report the proximity and thus the location of the mobile computer device to the either or both the display device and back-end server. The determination is whether that patron is at a predetermined location associated with the same outlet at which fulfilment and payment for the order can be arranged or is at or passing through the exit to the outlet.

Thus the second location determination of the patron's mobile computer device, indicates by the predetermined determined location that the patron likely has their complete order and that payment is about to be made. That determination allows the back-end server to initiate and perform a quantity of actions, including for example, displaying the patron ID or photograph and all the products of the order on a display device that is located so it can be seen by the server or checkout staff member and if convenient the patron. A further example, action would be to allow the server or checkout staff to change the order by removal or addition of product to match the products then in the passion of the patron. Thus the final products to be purchased The payment can be arranged in many ways using stored information relating to the patron, their order (as ordered or amended) as held by the back-end computer server system and data communication between the order display device at the outlet. There can be, in one embodiment, an input device, for example an NFC reader located at the exit or near the exit of the outlet. When the server at the outlet is satisfied that the patron has possession of the ordered product/s which can be done by them observing the order and patron identification on the one or a second of the order display device at the outlet and checked that the patron has all the product/s they ordered in their possession. The server can, in an embodiment, indicate using the user interface on an order display device, that a displayed order has been fulfilled and then can ask the patron to interact with an input device, by for example, bringing the mobile computer device close enough to the input device to exchange data representative of their acceptance that the order has been fulfilled. Mere proximity without a deliberate bringing the mobile computer device close enough to the input device will not trigger authorisation for payment. The proximity is typically zero distance (tap) to 0 to 12 centimetres. The use of NFC or BLE by the order display device or a separate input device to suit the operating system of the mobile computer device will ensure the transaction is securely and reliably undertaken as long as there is appropriate proximity. The separate input device has a communication capability with the back-end server which can by way of example use an Internet Protocol. The transaction is one of confirmation that it was the patron's mobile computer device due to the unique ID transferred at the time of the proximity of the devices. In the transaction described there are no monetary exchanges and hence no financial security mechanisms required although there can be security mechanisms used to increase the surety of the transaction, which by way of example, include encryption, hashing of the patron ID with other digital data, such as a digital ID of the mobile the International Mobile Equipment Identity (IMEI) is a 15 digit code split between a 14 digit number and a ‘check’ digit; an ESN: Equipment Serial Number; uniquely identifies equipment and is embedded electronically by the manufacturer. The ESN is in two forms the DEC (decimal) and HEX (hexadecimal) form; the MEID: Mobile Equipment Identifier; similar to an ESN or an MSN: Mobile Serial Number, also referred to as serial number (SN); is a 10-digit number. It is required for each SIM card capable device.

In an example where the input device is involved in the fulfilment action and the back-end computer server coordinates the order with the servers, the fulfilment process is such that payment is made in fulfilment of the patron's order using the back-end server wherein payment for the order has not been expected or required until that point in the process.

The user will make payment for the products intended to be purchased using stored details (on the back-end server) of a physical Credit Card, or use a venue specific cash replacement card or a pre-authorised version, so as to facilitate a monetary exchange once a patrons' intention to pick-up and pay for food and beverages (or services related thereto) is fulfilled by actual pick-up and provision of the service.

The location of the patron may not necessarily be at or even in the vicinity of the location serviced by that service provider's outlet to use the application when the patron wishes to alert the service provider of their intention to purchase an order. The placing of an intention to purchase order could, for example, be done while the patron is located at a vehicle parking station some blocks from the venue or stadium, or even parked under or outside the stadium, or even in transit to the venue or stadium by a vehicle for hire or even while on public transportation.

Thus by way of example, the patron uses the mobile computer device application (FIG. 3) to review the offers of food and beverage products and prices that can be provided at the venue they are attending or about to attend. Therefore, it is possible that the patron can review and create an intention to order before arriving at the venue.

For the purposes of providing an example, the patron 14 has an intention to pick-up two hotdogs and a medium size water beverage, and make that intention known to the service provider by tapping on the respective images 30 displayed by the application's user interface—twice for hotdogs and once of a medium size water beverage.

The back-end has preloaded in memory, various data relating to the patron resulting from the earlier registration information exchange, which involves the generation by the back-end computer server of a unique patron identifier. The back-end computer server may also associate the patron identifier with the products and services of prior orders, the time those orders were created and the time the orders were fulfilled, as well as the associated pick-up behaviour of that patron, for example, the location data acquired during use of the application from the time of creating the order to fulfilment.

The back-end computer server may also have stored data that indicates that the patron usually sits in bay 101, row 25, in seat 112 which is proximate to outlet #2. However, the back-end computer server may use geolocation systems (including beacons and GPS positioning methods in the mobile computer device and/or apparatus at predetermined locations associated with each of the two or more outlets) to confirm the current location of the patron, who has previously opted-in to their location being determined while using the application.

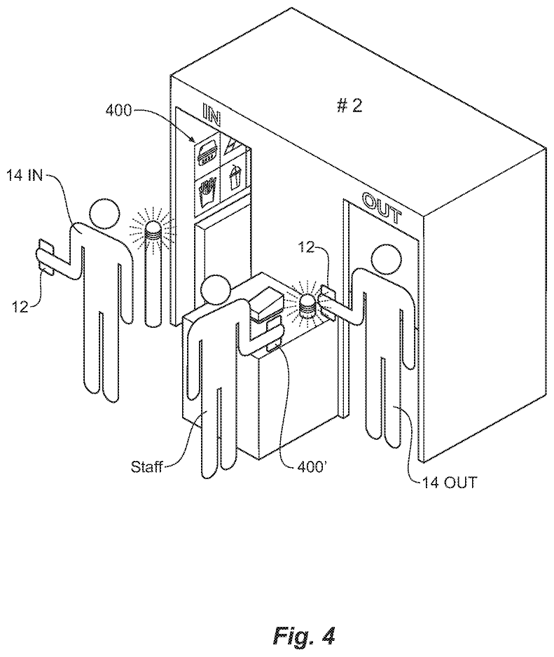

Thus the back-end computer server may use location determination information (LUs) to control and support the fulfilment function by issuing instructions for the preparation and making available of the order for 2 hotdogs and obtain a medium-size water beverage at outlet #2 (FIG. 4). The back-end computer server determines the most likely pick-up location. However, the order fulfilment process may or may not be initiated by the patron, since the order is merely an intention to purchase, and the provider of the requested food and beverage products and associated service can rely on the back-end computer server recommendation to begin to prepare an order or not.

The back-end computer server receives the order and treats the order as an intention of the patron to pick-up their order. The back-end computer server, however, does not rely on the patron actually picking up the order at a particular outlet or that the order will ever be picked up.

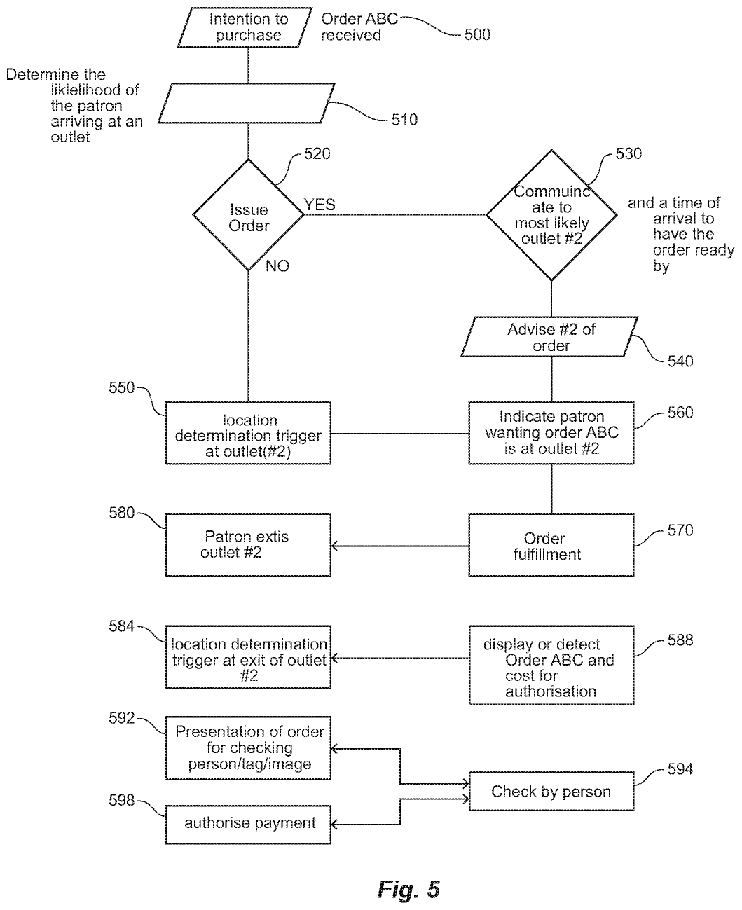

The back-end computer server 18 (FIG. 1) may process each order 500 (FIG. 5) and the allocation process 510 as to which outlet (#2) that order is to be fulfilled as an order to be fulfilled, and the service provider 520 can chose to ignore (NO) or accept (YES) that indicative information from the back-end computer server, about which outlet the order is most likely to be picked-up 530. Thus whether to act on the desirable preparatory steps of preparing the order 540 in anticipation of that pick-up. The back-end computer server as far as that intended order is concerned, may not change the predicted fulfilment location if there is an updated location detection of the mobile computer device (most likely in the possession of the patron) and who is closer or arrived at another outlet and does not process any differently if the intention to order is never fulfilled.

The back-end computer server may use a body of data which is collected over time to support processing to provide a best estimate of the outlet that the patron will pick-up the products from and may also provide an estimate of the time of arrival of the patron at that outlet to pick-up the products previously indicated by that patron's intention to purchase notification. Every time an intention to purchase notification is fulfilled and the time that the fulfilment took place for that particular patron, that information can be used to increase the likelihood of the correctness of the next estimate provided by the back-end computer server about which outlet that person will use and also the time they are most likely to arrive at a particular outlet. The back-end server repeatedly determined, based on the determined distances between the mobile computer device and the one or more outlets the likelihood that the mobile computer device will attend a particular outlet location and the time at which that will most likely happen which can be the current time as the patron has arrived at the outlet.

In an embodiment there is a back-end computer server having a digital data storage and executable code. The back-end computer server is configured, to receive location updates from the patron's mobile computer device and to receive or generate the unique identifier of the patron and provide the unique identifier to the patron's mobile computer device. The back-end computer server is also configured to receive an order for one or more product from the patron's mobile computer device. So as to configure the back-end server in readiness for distance calculations and to determine other parameters the back-end server is also configures to store in the digital data storage and permit reading from the digital data storage: the location of each outlet which can fulfil the provision of the one or more products; a location update of the mobile computer device; a unique identifier received from the mobile computer device; the order received from the mobile computer device for one or more products; and associate the received order for one or more products with the unique identifier. Once the back-end server has the noted data the executable code is configured to determine the likelihood of the mobile computing device attending an outlet. That determination is based on repeatedly determining the distance between the location provided the mobile computer device and the location of each outlet and further determining based on the determined distances, the likelihood that the mobile computer device will be in proximity to a particular outlet location. If the determined likelihood is greater than a predetermined likelihood, the back-end server is configured to communicate a predetermined action to the particular outlet. The action communicated being - make the order at a predetermined time. In an embodiment, the predetermined time value is at least based an average mobility pace of the patron and the distance to the outlet and may be the current time.

In an embodiment, the back-end server in receipt of multiple of such intentions to purchase as provided by multiple patrons may include a rule that there is no need for any particular outlet to fulfil each of the orders. However, such a rule is very unlike a rule applied by all previous food and beverage product fulfilment systems which requires the patron to contact or nominate a specific outlet and order what is available from that outlet, commit to receiving and paying for the order (sometimes even pre-pay for the order so that anyone can pick-up the order) and for the outlet to receive the order and fulfil that order when the patron or their agent or a delivery service arrives to pick that order up. The back-end computer server and communication to and from the outlets, in an embodiment, do not require or depend on an association between the order having an associated intention to purchase and any particular outlet. However, any interaction between the patron and the back-end computer server is thus a unique interaction, which is reliant on the use of the users' mobile computer device application, the patron's uniquely associated identification and selected features of the mobile computer device. There may also be associated location determinations (for example using proximity sensors at predetermined locations associated with a particular outlet which detects the proximity of the particular patron's mobile computer device) and procedures at the outlet to make the arrangement work, and this system and operation of elements of the system overcomes prior problems and supplier centric practices, and provides an alternative to all previous food and beverage product fulfilment systems which is more favourable to the patron without unduly disadvantaging the supplier.

In an embodiment the determination of the likelihood (using another prediction target) of the mobile computing device entering a particular outlet is based on repeatedly determining a value using a neural network or a machine learning methodology, which uses currently available data (over a minimum predetermined period or during a pre-determined period window) and optionally using stored data as additional input, and outputs an estimated likelihood of the mobile computing device entering a particular outlet.

In an embodiment the period used was 1 second between sequential outputs of the neural network which provided a likelihood value. This window could be larger or smaller, dependent on the desired responsiveness of the system and computational power of the back-end server. Three outputs of the network (to which can be added as many outputs as are required noting that the groundtruth can be obtained) are used to make up the control actions which represent the likelihood of the mobile computing device entering a particular outlet; advise a particular outlet a particular order is to prepared for fulfilment up at a predetermined time; or reassign the order to another outlet; or do nothing and repeat the determination for the next period. These output classes are a probability of which action to take, given the input set, and when all output classes are combined equal to one. This is representative of a softmax layer which assigns decimal probabilities to each class in a multi-class problem and decimal probabilities add up to 1.0. This additional constraint helps training converge and is used within the neural network, as the final layer, to generate the normalised probabilities for the three outputs.

The input to the network may consists of:
the distance measurements between the location of the mobile computing device and the outlet normalised to the maximum value at the time of each distance determination
the standard deviation of the distance measurements (1 value)
the average of the distance measurements (1 value)
the maximum value of the distance measurements (1 value)
the sum of all pairwise Euclidian distance calculations for the distance measurements (1 value)
an historical fact (one or more of and not limited by: the number of time a patron has not picked an intention to purchase order; the number of times a particular outlet is the outlet used by a patron; the number of times the prediction of the time to arrive has been correct for a patron; the number of times the prediction of the time to arrive has been incorrect for a patron).
   However, more advanced features can be used. For example, the time-serials of the patron's location. Also, instead of using neural networks (the method described here is called multi-layer perceptron (MLP)), other supervised machine learning models, including random forest, kernel SVM etc. also work well.

The neural network is trained on data acquired from in one example the use of past distance measurements over time in a test arrangement for a wide variety of users (physical states including those using wheelchairs and those with gait impediments) during set periods of use of the application or for test cases and beta testers. The generated data is stored at a predetermined time interval for a predetermined period. Labels or ‘groundtruth’ data is collected from the physical characteristics at each time-interval and assigned against a preferred control action class, so time at each location determination are stored serially over a variety of journeys by one or more patrons. Other algorithmic approaches can be used, such as pattern-based optimisation, derivative-based optimisation, regression analysis, etc.

The characteristics of a particular neural network include the number of input neurons, the number hidden layers and the number of neurons in each of those layers and the number of output neurons and why generally those numbers were chosen. The determination of the distance measurement input, is one example, however, it might be more appropriate to use the time of travel for the particular mobile computer device user as input to predict the adjustment that is required to initiate an action in reaction to the arrival time of the user to an outlet from one location or another. If the latter is indeed the desired case, then the neural network explanation provided is but one version and is described in a manner that discloses the basics of such an arrangement, the details will be known to those of skill in the art.

The goal of a neural network is to model the relationship between input sets of data and a predicted aspect of that data. In an embodiment, the input data are the travel times of one particular user but the travel times of multiple users any also be useful. Presented as a normalised vector of values between 0 and 1, where 1 is the maximum value (likelihood of arrival at an outlet) seen at that time step. Additional inputs may be added such as the raw value maximum and standard deviation. The output of the neural network is three probabilities which represent the possible control actions that can be taken, namely; the likelihood of the mobile computing device entering a particular outlet; advise a particular outlet a particular order is to prepared for fulfilment at a predetermined time; or reassign the order to another outlet; or do nothing and repeat the determination for the next period. The intent of the model is to predict which control action leads to a reduction in patron wait time picking up their order, whilst maximising the time utilization of the outlet order fulfilment staff member/s. This results in a range of savings for a wide range of patrons and ultimately the operators of the outlets making them more profitable as multiple saved seconds are multiplied by a large numbers of orders.

In an embodiment, the neural network structure consists of a number of virtual neurons that exchange information with each other, wherein the neurons are arranged into three or more major layers (the total number of layers in the network is described in this embodiment. The first layer (1) is the input layer that holds as many neurons as input variables. The second transform layers (2) being one or more of the hidden layers that each hold a number of neurons in each layer. The third layer (3) uses a softmax layer process to normalise the output from the hidden layers (2) and transform to probability classes. The fourth layer (4) is the output layer that holds as many neurons as output variables (three control action classes—advise a particular outlet a particular order is to prepared for fulfilment at a predetermined time; or reassign the order to another outlet; or do nothing). In an embodiment, 21 input neurons are used for layer (1), 25 neurons are used in a single hidden layer within layer (2), 3 softmax classes are defined in layer (3), finally being passed to the output layer (4). More or less neurons in each of the hidden layers can be used, however if too many are used overfitting may occur, reducing generality to multiple users. If too few hidden neurons are used then the prediction may be inaccurate.

Persons skilled in neural network design will understand there are many possible combinations of network architecture which can result in acceptable performance. The approach used to determine the configuration above was;
a. Input layer size determined by number of input variables
b. Output layer size determined by number of control actions as softmax classification was used
c. Number of hidden layers: it is commonly known that more than one is rarely needed for most applications using a feed forward neural network
d. Number of neurons in hidden layer: first start with the average value between the number of input and output size (e.g.—20 input, 5 output, hidden =(20+5)/2=12)
   i. if performance is below 95% accuracy when tested increase the number of neurons.

During training (which will be described later), the output can be checked against training data since the actual arrival times are known but that can be totally dependent on the circumstances of the event, and thus checked against the “truth”, i.e. whether advise a particular outlet a particular order is to prepared for fulfilment at a predetermined time; or reassign the order to another outlet; or do nothing actually create the savings alluded to.

The output value of any of the neurons in an inner layer and the last layer is determined by processing the output from all the neurons in the preceding layer connected to that neuron. Very importantly, there are corresponding numeric weights assigned to each neuron-neuron connection through an activation function. It is crucial that the weights are assigned values which tend the determination of the activation of the neuron in that layer towards a component of the abstraction desired, and of course there are weights to be allocated for every connection between the prior and subsequent hidden layer, and then eventually the weights for each connection between the penultimate layer and the output layer. Those weights are not dynamic but pre-set and a backpropagation technique was used to do so. There can also be the use of a bias factor (positive or negative of any non-zero numeric value) applied to the sum of all the weighted activation values to bias the turning ‘on’ of that neuron, i.e. make that particular neuron meaningfully active. Bias values were also computed during the back propagation process, as is standard practice in neural network training.

It may be that there is a need to apply a Sigmoid or Rectified Linear Unit (ReLU) function to create a number between the desired range of say 0.0 and 1.0. Other functions such as Radial Bias, or Trapezoidal, functions can also be used. Indeed, supervised machine learning models may apply to the type of data described.

Thus there are to be potentially many of weights and biases to be determined before the neural network is capable of reliably determining the action (advise a particular outlet a particular order is to prepared for fulfilment at a predetermined time; or reassign the order to another outlet; or do nothing) of the product ordering system given a representative arrival/entry time of the mobile computer device and it user at an outlet.

The training of the neural network was conducted by minimising a cost function using gradient descent and assessing which of the weight changes matter more than others when using the training data. The backpropagation algorithm applied to the weights and biases to improve the training was likely a call to a known subroutine.

The method/s used to collect the training or “Ground Truth” data which is collected and performed ‘off-line” can vary and how that training data is used can greatly vary as well. The collection of training data is not done by the final user, but in an embodiment, multiple willing users could indeed provide training data to add to the existing training data. Ideally, the training data is collected using a wide variety of users of different physical characteristics, to provide a level of training for use in the user device. In the illustrative embodiment disclosed, there is a neural network in the user device that works within the control algorithm operating within back-end server.

Weights are tuned by using a back-propagation algorithm, by using a large number of training examples, where both the input data and the corresponding output data are known. The neural network uses the training input data and the current weights to calculate a vector of output data. The success or otherwise of the settings of the neural network is determined by calculating the squared error between the vector of estimated output data and the corresponding vector of known reference output data. The squared error is then propagated backwards through the neural network, and each weight is tuned such that the error is minimised. The training procedure is an iterative process and continues until the error between estimation and reference is sufficiently low, it being important to realise that there are no absolutes only high probability of the value associated with neuron being indicative of the appropriate control action.

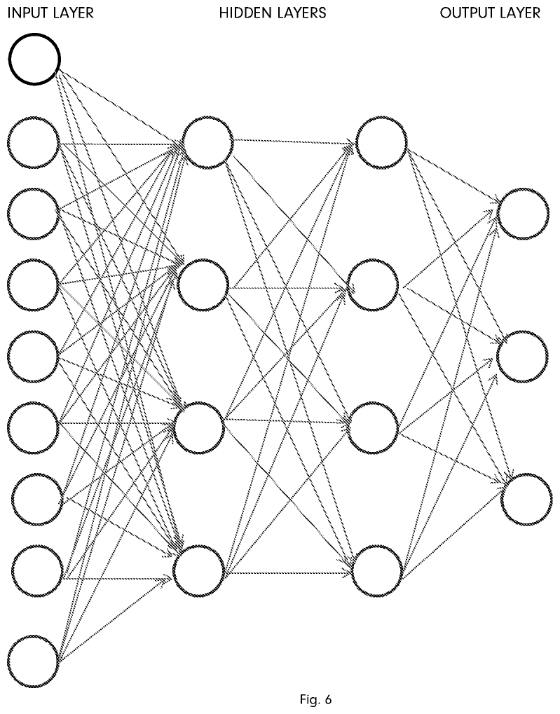

FIG. 6 displays a generalised version of the linking of the output of the working neural network with the determination of the required action, wherein the action applied is the maximum likelihood value (max), but must also be greater than 95% confident.

The generalised version depicts an array input nodes at the input layer and comprised the one or more data available from the memory store of the back-end server which can be retrieved as required. So it might be that in synchronisation with the LU period (say for example every second) the data that is required, say the location of the mobile computer device, the calculated pace of motion of the patron, a data representative of the number of times the patron has not pick-up an order, the number of times the patron attends each outlet or a particular outlet, etc.

The generalised version depicts an array of nodes at the hidden layer/s in this generalised version there are two hidden layers. The lines joining every input node to every first array of nodes in the hidden layer represent the application of a weighting to the relationship between the input node and the determined node within the first hidden layer and each weighting is set based on the training data. Although in some machine learning algorithms the weighting can be dynamically set. The lines joining every node in the first hidden layer to every node in the second hidden layer represent the application of a weighting to the relationship between the node in the first hidden layer and the determined node within the second hidden layer. The lines joining every node in the second hidden layer to every node in the output layer represent the application of a weighting to the relationship between the node in the second hidden layer and the determined node within the output layer.

The likelihood measure in % form is useful to illustrate that the % likelihood of a pickup at any outlet. If the % measure is below 50% when the patron is located outside the venue at the time of creating their order the do nothing output means that the determination is not ready to communicate a predetermined action to a particular outlet even though the nearest outlet to the venue entrance could be the patron's intended pick-up outlet.

The action by the back-end server being one of: i) make the order at a predetermined time, or ii) nothing. The determination can be repeated at 10 second intervals while the patron is located external of the venue. However, as the patron is located closer and closer to the venue the determination can be repeated more frequently as say one second intervals. In an embodiment the predetermined time value is at least based on the average mobility pace of the patron and the distance to the outlet. The mobility pace can be determined by calculation using the distance change from location update to location update or the location update interval over a minimum, say five location updates, or alternatively the value can be looked up from a stored value previously calculated during past usage of the application by that patron or calculated on the fly using the stored location data associated with that patron.

Pre-defined values for confidence and detection of a patron (maximum and average) can be varied depending on patron testing. These values could also be updated by through a configuration process at any time performed on the back-end server. The initial values threshold values of 90% and less than 90%, for the likelihood that the patron will enter an outlet and the do nothing actions, were chosen during testing. The location of the user isn't needed as the network is trained using many locations, making it more robust and then capable of dealing with seemingly random locations. The location could be inferred, and to enhance the distance determination it may be possible to compute the direction of movement of the patron and their mobile computer device, or to do nothing. If the determined likelihood is greater than a predetermined likelihood that the patron will enter a particular outlet then the back-end server will communicate a predetermined action to the particular outlet: the action being make the order at a predetermined time; otherwise repeat the determination.

The predetermined time can be calculated from the determined distance between the patron at the last LU and the nearest outlet divided by the determined average mobility pace which provides a period in minutes and seconds, which can then be communicated along with the action to the particular outlet for display on an order display device. It may be that that communication is direct to an order display device or that there is a service provider 15 computer server which passes the communication within a venue specific communication system.

In an embodiment, the predetermined time value is at least based an average mobility pace of the patron based on real time location determinations of the patron over a period. The predetermined time value can be based on historical information of location determinations of the patron over a period of time wherein the distance travelled between a prior location determination and time of day and another later location determination and time of day (which may be the latest) provides the basis for a calculation of distance over the period between determinations. The distance the patron is determined to be from to the outlet based on the latest location determination and the location of the nearest outlet can then be the basis for a calculation of the time (a predetermined time) for the patron to arrive at the outlet.

The back-end server will also collect a great deal of data representative of the habits of patrons including their order history, their history of: having each order fulfilled or not; changing or adding to their orders, the route they take; the times of day or time with relation to the event program (say at half time) that they create an order; the location of the patron is when they place each order; and any other data that can assist to predict the likelihood of the patron placing an order and the likelihood of the order being fulfilled at a particular outlet.

The back-end server will also collect a large quantity of data representative of the products and services ordered along with the date, time of day and additional meta-data such as the event type, teams, weather, actions by patrons, unusual events that affect purchases or lack thereof, and registered and non-registered patron quantities. This data can be used by the supplier to draw conclusions as to the effects on product and service demand.

The following scenario assists to illustrate an example of how an embodiment of the back-end system operates when it determines which outlet to send an order while still allowing for the rule that the order may, not be picked-up at the most likely outlet or that the patron will ever pick-up at any outlet.

The patron, as described previously, has previously provided their intention to purchase by ordering and thereby an intention to pick-up two hotdogs and a medium size water beverage, the order 500. The back-end computer server 18 (FIG. 1) as result of executing code that the determined likelihood is greater than a predetermined likelihood and communicates a predetermined action to the particular outlet: the action being one of: i) make the order when the action is received. In the embodiment depicted in FIG. 1 the back-end server provides the service provider 15 computer server data 530 (FIG. 5) indicating that outlet #2 is the most likely location at which the patron will pick-up their order. The service provider computer also receives 540 from the back-end computer server the order 500. Since the action has been communicated from the back-end server without a predetermined time at which to make the order the order should be made immediately. When the predetermined time is a quantity of minutes and seconds the order can commenced to best match the likely time of entrance of the patron to outlet #2.

The patron on their way to pick up those products decides to meet a friend near a bar which is close to outlet #3 and while there stays for some time beyond the period anticipated by the back-end computer server for the patron to have arrived at the outlet first determined by the back-end computer server (outlet #2).

At outlet #2 the order is waiting but not picked up at the time the back-end estimated the patron would arrive to pick-up the order they indicted an intention to purchase. The outlet may deal with the products in a number of ways. In an unlikely scenario, one way is to waste the ordered products as no pick up occurred. In another unlikely scenario, a second way is to use the products prepared in anticipation of pick-up by the patron for the fulfilment of another order or a walk-up patron. The intention to purchase order can be used, regardless of whether the other intention to purchase order is for all or a part of the unpicked-up order, or if un-ordered pick-up needs one or more of those products. The scenarios described could not be supported in prior order fulfilment systems and in particular, the patron may: a) be charged for the order even though they did not pick that order up; or b) could be charged a fee (various clauses and codes may apply—such as a no-show fee); and c) the lack of order pick up may be recorded and a predetermined number of no-shows may trigger a refusal to accept orders from that patron, etc. It is also possible in an embodiment for the back-end server to detect that a) the order has not been fulfilled, and b) the patron is currently closer to outlet #3 and once the determined likelihood in respect to outlet #3 is greater than the predetermined likelihood then a communication is sent to outlet #3 with or without a predetermined time value for the patron to enter outlet #3.

Such possible reactions by the supplier to the no show of a patron are completely supplier centric. The supplier's reaction to the scenario includes the assumption that the patron is at fault since once the patron places an order, that patron has committed to payment for that order regardless of the patron's immediate needs and wants. Ultimately the supplier has placed their convenience and needs well over and above those of the patron.

The scenario described is not unusual and although the reason for the patron's no show is not compelling and in the prior systems is likely not worthy of any special consideration by the supplier using a prior fulfilment system. The pressures of the fulfilment task are very high, especially on the staff trying to cater to tens if not hundreds of orders between the relatively short breaks of the sports or entertainment event.

A determination by the subject arrangement and described herein in the scenario described previously can be achieved in a number of ways, and an example of one way is to make the determination process performed by the back-end system decrease the likelihood the patron is going to arrive at outlet #2 and increase the likelihood that the patron is going to arrive at outlet #3. If the likelihood over time for none or more location determination inputs to the back-end system and the determination portion of the method and apparatus (geo-location, time standing still in a location, etc.) is at or increases to a threshold that makes it more likely that the patron will pick-up at outlet #3, then the back-end advises that outlet #3 should prepare two hotdogs and take a medium size water beverage from the fridge. As it turns out the patron picks up at outlet #3 as is triggered by their arrival at a predetermined entrance to outlet #3. Furthermore, by accepting the products at the exit to outlet #3, the patron is committed to pay and can do so, either with the mobile application (linked by the application to a payment method) or a separate value exchange transaction which for time saving purposes is less economical than using the application and since that is the case there is likely to be disincentives to do so.

Next time that patron uses the application and is sitting at their allocated seat in the same sports venue and indicates an intention to pick-up two hotdogs and a medium size water beverage, the likelihood they will use outlet #2 may be lower than the prior time. Therefore, as the back-end computer server accumulates more and more data about the actions of that patron (unique id), the more likely the determination process of that back-end system will be able to adjust to the likely behaviour of that patron.

The supplier of the outlet offerings can have products available for pick-up quicker if they decide to accept the determinations made by the back-end computer server and thus are advised ahead of time of the demand for certain of the products (and services) they are able to provide. The likelihood of any particular patron picking up at outlet #2 may be determined as high, and it will also be in the data collected over time by the back-end computer system, that that patron will take 5 minutes, on average, to arrive at that outlet which also assists with the provision of the products at a suitable time of the arrival of that patron to that outlet which is communicated as a predetermined time of arrival for that patron.

Additionally, if the order crated by a patron involves a product that takes a certain time to prepare then it is possible for the back-end system to provide a communication which takes that preparation time into consideration thus, say the likelihood of the patron is 95% and they are determined to be 10 minutes away from the particular outlet #2 and one of the products ordered will take 15 minutes to prepare, then the outlet can be communicated to immediately and advised that the patron is 10 minutes away, and it is also be possible for the back-end server to advise the patron that they may need to wait for their order if they intend to pick up at outlet #2.

However, there may be multiple patrons (possibly hundreds, if not thousands, of patrons) at a large venue using the intention to pay approach. Therefore, from the supplier's perspective, the venue wide ordering that will occur will likely be on the basis of all products indicated as being intended to be purchased, end up being supplied to all the respective patrons regardless of where in the venue the products are picked up. The outcome for the supplier being that it is likely that any order not picked up at one concession outlet will be picked up as part of an order that is picked up at that outlet as a result of an order fulfilment to non-user of the described system, or patrons that chose to pick up their products at that outlet which may be different to the outlet determined by the back-end server.

It is still useful for the supplier, in an embodiment of the back-end computer server to, as accurately as possible determine where the intention to order products will be picked up. However, the overall system including the various arrangements to determine location, including proximity sensors to detect arrival and exit, work together to make it possible to supply products (and services) to all patrons, whether they are users of the application or not.

The determination, of which outlet is to prepare which products in quantities to supply the received intentions, is especially important before a break in the arena entertainment or sporting event (quarter and half time breaks). Providing food and beverage product orders in advance of those known and well scheduled events will allow each outlet to operate more efficiently since they will have more time to meet demand rather than reacting to demand. Such an approach ensures that there is a product to sell and staff to prepare and service/approve each pick-up and associated sale. Although much the same advantage would result from a system that required the patron to commit to payment and pick up at a designated stand, that is a service that mostly benefits the supplier of that service since they tell the patron when and where they can pick-up and make the patron wait, if the order is not ready, and either pay for the products at the time of making the order or waiting in line with other patrons and offering to pay in the same manner everyone else pays, by card or cash (less and less the case)—and that does not assist the patron nor make them feel that their order is valued by the supplier.

The patron may change their order associated with their intention to purchase at any time before purchase, and they may choose not to pick up their order since it was only ever an intention to purchase.

In an embodiment the location determination capabilities of the mobile computer device can be greatly assisted by the proximity of multiple beacon and other location determination devices. A first proximity determination provides a trigger when the patron having the mobile computer device in their possession is located at a first predetermined location associated with a first of the two or more outlets. The mechanism for making the proximity determination is to use an available location determination of the mobile computer device (likely in the possession of the registered patron). One mechanism is the use of the Location Updates that are available from a location determination circuit in the mobile computer device, typically a GPS chip or chip set which uses the radiation and signals received from preferably four satellites in Geo-Stationary orbit about the globe. The location determination chip/s is also able to use other communication systems to make a location determination or a fusion of them. The chip/s provide a location update at a predetermined rate with a calculated accuracy typically multiple times a second with a for example (>90%) accuracy. The first predetermined location is the predetermined entrance to an outlet or predetermined queue at an outlet and determining the proximity of the mobile computer device to the first determined location can be a matter of creating a geo-fence at the entrance, which is one example of a predetermination of the entrance. For example, a geo-fence boundary can be defined by the creation of a line or a portion of a boundary of an area. The geo-fence line can by way of example, be located at a doorway, or a crowd controlled entrance pathway, or at or near the order pick-up counter. Depending on the accuracy, the difference between the predetermined location and the actual location can be a matter of meters. Therefore, GPS location determination alone is not always useful and that is especially the case inside buildings and other large concrete and steel structures.

Alternatively, there are many other types of devices that can be used to assist with location determination adapted to detect the proximity of the patron's mobile computer device to a predetermined entry to the outlet. Beacons and Radio Frequency Identification Devices, Bluetooth transceivers, WiFi stations and the like. The most accurate is the use of a Near-Field Communication (transceiver) device, since they are designed to transmit within a range of near 0 to 12 centimetres and as such a mobile computer device which also has an NFC device must be placed within that distance range to be detected. Devices with NFC are said to be tapped together or against one another and in doing so are then within the required range. Once the devices are co-located that indicates their proximity to one another and in this situation the patron can be recorded as having entered outlet #2 as a result of the trigger 550.

It might also be useful to provide a Near Field Communication reader that requires a tap (near touch) of the mobile computer device to indicate proximity to an entrance or other significant location associated with an outlet or some part of a venue.

It is be an alternative to display a Quick Response (QR) code at the predetermined entrance or trigger point. A QR code is a machine readable code consisting of an array of visually contrasting squares (typically black printing on a white background). The QR code can represent a Uniform Resource Locator address or a code representative of the identification of the particular locations at a particular outlet and that the reading of the code by the patron's mobile computer device is indicative of the patron's mobile computer device being located at the predetermined location, such as the entrance to that particular outlet.

The back-end system can also record the time of arrival of the patron and add that information to the body of information associated with that patron for future use in determining the most likely outlet they will use and their most likely time of arrival, and that information can be associated with the processing of that patron's next intention to purchase order.

This first proximity determination is communicated to a back-end computer server wherein both the device making the proximity determination and the back-end computer server are adapted to send and receive a notification that a patron having an intention to purchase is within proximity (by way of explicit example the predetermined location of the entrance) to the outlet or one of the one or more outlets, and in this example the entrance to outlet #2, based on the triggered determination.

The back-end computer server then provides data 560 to a predetermined order display device 400 (FIG. 4) (or two or more of many order display devices which can also be a device of the same functionality but different physical format as the device on which orders are checked by staff, as also illustrated in FIG. 4) at the appropriate outlet, in this example the food preparation staff and/or the order fulfilment staff in proximity to the order display device at outlet #2 to alert the relevant staff at the outlet of the patron's arrival or immanent arrival within a determined period or at a determined time to that outlet. The order previously advised 540 which, as indicated, is still only intended to be purchased by the patron is prepared 570 and is then fulfilled 580 by the patron taking possession of the products, at that time the intention to purchase transforms into an actual purchase. Alternatively, if the service provider did not use the order data or the likely arrival time of the patron or they arrived even earlier that predicted, then the order can be commenced to be prepared 570. Yet further alternatively, the patron merely takes possession of the items they want up till then had intended to pick up (being two hotdogs and a medium sized water beverage) from the stock on display and makes their way to the exit of outlet #2.

The arrival of the patron at outlet #2 was correctly anticipated, however, there is no consequence to the patron if they decide to arrive at outlet #3 (assuming that they know the products they ordered will be available from outlet #3). In such a scenario, the trigger is still generated but then outlet #3 is notified by the back-end computer server of the arrival of the patron, since the likelihood of arrival at that outlet is in excess of the applicable predetermined threshold.

The patron may be provided their specific order since the order providers can be prompted by the devices within their view of the identity of the patron or that the lines traversed by patrons and the order within which they are determined by a proximity determination arrangement permits the appropriate patron to be identified and provided by a back-end computer server their particular order. The patron physically takes possession of the order and has the option to add to the goods by choosing goods that are on display or orderable and even though not strictly part of their original order they are not discouraged to add items to their possession.

In a preferred embodiment but certainly not an essential feature, a second proximity determination provides a trigger 584 when the patron having the mobile computer device in their possession is located at a second predetermined location associated with outlet #2, in this example the payment counter near the exit of outlet #2 at which is located a predetermined order display device 400 and an outlet staff member to check the order against the products in the possession of the patron at that location at that time. The second proximity determination is communicated to the back-end computer server system wherein a second proximity determination device is adapted to send and receive a notification that a patron having an intention to purchase is within proximity of the second predetermined location (the exit or an exit queue thus being a predetermined queue at the outlet) of one of the first of the one or more outlets, in this case outlet #2.

The back-end computer server provides data 588 to the predetermined order display device to alert an outlet staff member at the second predetermined location of the first outlet (being in this example outlet #2) at which the patron has picked up their order and is then presenting that fulfilled order 592 to them for checking against the displayed order and by way of example an authorised image of the patron linked by the unique patron ID.

There can be a mechanism included in each of the order display devices that identifies that that device is within proximity of the second predetermined location to the back-end computer server or alternatively the outlet staff member logs that they are at that location or performing the order checking function and the back-end computer server is able to send relevant data to that predetermined order display device or the order display device has a function that can be designated as a second proximity determination provider.

In an embodiment the presentation of the fulfilled order is to an outlet staff member at the outlet who inspects the presented food and beverage products, to check that they match what is displayed on the order display device. Such a process can be done without handing the products to the staff member, thus reducing time and minimising contact with the ordered products which is a health and safety improvement for the patron and the staff member. It would also be possible in an embodiment for the outlet staff member tasked to check the products in the possession of the patron against their order using an augmented reality glasses, eye wear or headset, which allows the staff member to see the patron, glance at the products in their possession and see the order as well, or in yet a further embodiment the augmented reality visual aid also includes a video camera and the images captured by the camera can be used to match that patron's order against the products in their possession. Yet a further embodiment includes a camera trained on the second predetermined location such that a patron in possession of their ordered products can be scanned and the match approved and the patron exiting the outlet without the need to human intervention.

Even if more products than ordered are included in the products taken from the outlet by a patron, that situation can be dealt with off-line and a range of actions taken, including but not limited to, automatically increasing the charge and advising the patron at the time using the application on the relevant mobile computer device; sending correspondence indicating notice of the additional charge along with photographic proof of the extra purchases via the application or to a nominated email address; and if there is any doubt doing nothing, thus enhancing customer convenience and minimising disputes, however repeats of such results can initiate a process of not allowing that patron to continue using the intention to purchase application.

It may be that the patron indicated their intention to purchase those products and they have not yet done so, and they have chosen to take possession of additional items, those items can be noted and entered into the outlet server's device and effectively added to the order on the fly. This is no different to the outlet server dealing with a patron that does not use the application so that function and patron convenience is not a burden to the outlet server and the system accommodates the then additional desires of the patron. This arrangement thus does not discourage add-ons and ultimately allows the patron to feel in control and the outlet and supplier to sell more goods.

In an embodiment, the patron can authorise the charge for the products in their possession at the time, by interacting with the mobile computer device application and the order display device. There are multiple ways in which that interaction can take place. It can also be possible for the patron to pay using alternative means, such as a stadium stored value card, an alternative credit or debit card or have a friend pay with their card.

In one example, the interaction is the mere ‘touch’ (bringing the mobile computer device within NFC proximity) of the outlet's payment device or the order display device. An NFC device located in the vicinity of the exit or handheld by the checking outlet staff member can be used to receive the NFC communication being generated by the patron's mobile computer device. In an example, the authorization of payment can be directed through the back-end server using stored patron details, such as their Credit Card details to facilitate payment through the payment gateway and payment institution 13 (FIG. 1).

Alternatively, payment can be made using a suitably instructed EFTPOS device to receive the payment from the patron using their own choice of payment—direct debit, credit card or stadium pre-payment card. In an example, the EFTPOS device can be preloaded with the total cost by the back-end server as soon as the patron triggers a second location determination by the presence of the patron's mobile computer device thus saving time and effort by the outlet staff member having to enter the total and sometimes not getting that amount correct. If a patron decides to take possession of additional items the staff member will interact with the order display device and then a new revised total is communicated to the ETPOS device avoiding human interaction in the manual setting of EFTPOS amount to be charged.

Alternatively, the payment authorisation can be protected by a two-factor authorisation performed by the patron when using their mobile computer device to pay for the order, such a password/pin, and face recognition, or a finger print.

In some circumstances however the patron is not able to be the person to pick-up the order. The application can thus be set by the patron to authorise the pick-up by another person that has possession of the patron's mobile computer device. Thus, only requiring for example NFC touch at the two predetermined locations and for payment authorisation.

It may be that a friend of the patron has been asked to take possession of the order and has the patron's mobile computer device with them. It may also be that the mobile computer device is in a Locked State. It may be possible, depending on the mobile computer device operating system to still use location determination functions or NFC touch location determination and authorisation of purchase function controlled by the application operating on the patron's mobile computer device. The relevant authorisations by the patron may be required and those authorisations may limit the use of that functionality to only time when an order is outstanding or other conditions deemed to be necessary or acceptable to the patron. Even though it is highly unlikely that the mobile computer device would be used by an unauthorised person to pick-up an order a risk exists but it is a commercial decision to accept that risk.

The outlet staff member thus has minimal interaction with patron who invariably is eager to return to their seat and the staff time associated with payment compared to normal transactions is reduced.

Subsequent to the payment transaction an email or other patron selected means of communication (Short Message Service of example) can be sent to the patron confirming the order fulfilment and payment receipt by the service provider. As mentioned if the creator/developer has a middle position in the transaction they are able to provide additional services and surety of payment, holding of unexpended funds in stadium cards and thus provide administration of those cards for a service fee but that unburdens the stadium or venue owning entity of that responsibility.

The use of further location determination means such as a proximity sensor is possible. One example is having a proximity sensor for detecting the patron's mobile computer device at the beverage bar. A trigger once generated can cause data to be provided to the bar staff member along with the order so that they can immediately greet the patron by name and be simultaneously preparing the beverages ordered. Further proximity sensors can be arrayed along any queue leading to the bar (thus being a predetermined queue at the outlet) so that proficient bar staff can be preparing some of the known coming orders ahead of the arrival of the respective patrons at the front of the predetermined queue. Such a situation could be when asked to provide three glasses of the same type of beer and the bar staff knows that the soon to arrive patron wants one of those as well the bar staff member prepares four at the same time. A small incremental added time to one patron reduces the time it would have taken to supply that same beer when the patron reaches the front of the predetermined queue at the outlet.

There is the potential to collect three types of user and system related data. Patron data name/address, Credit Card details, contact details, phone number, and can include dietary restrictions which meets duty of care requirement and is made available to the suppliers and outlets at the time of provision of the intention to purchase order.

Venue data about their operation the food/beverage and services they are able to offer patrons, and the ability for the venue operator to change the data relating to food and beverage products on offer, the associated pricing, and the outlets that have certain food and beverage products, using a virtual console and the ability to tailor the view or orders, changes of orders and the costs in preparation for authorisation of payment when an order is fulfilled—again by being able to make changes using a virtual console to the menu, availability of concession outlets, specials, images, prices. Yet further the ability to accumulate data associated with intentions to order, fulfilment performance, staff performance and stock tracking and a host of other data that can assist the venue operator to manage their business.

Aggregated data from multiple venues with source de-identified data that can be of use to the overall collection of users of the system. Such data can provide instant feedback to POS device systems to indicate concession performance in ‘real’ time not just historical—as there has been a problem of how to quantify sales across time, quantity, quality and the real-time presentations of such data to venue operators.

As an alternative to NFC as some mobile computer devices do not have NFC or have NFC restricted to only certain applications, a 2-dimensional code/QR code can be read or generated by the mobile computer device. Such codes can be created to order especially if there is a network communication issue such that computer to computer communications is not possible. Thus the outlet and the mobile computer device can generate codes that can include an amount of data which can include the patron id, venue, location, order data, etc. Readers of such codes can be incorporated into proximity arrangements and Point Of Sales Devices (POS) or the codes can be stored on the POS devices and up-loaded to the back-end computer server once the communication network is working again. In such cases it is also possible to ensure such an arrangement does not incur liability for unconfirmed Credit Card transactions less than $100 in value. Thus the patrons and the supplier are able to transact business for previously created intentions to purchase orders.

Many other features result from the combination of an intention to pick-up and the flexible supply of those products intended to be picked up, but they result largely from information provided by the patron's actions/location over time, and the back-end computer server's continuous assessment (using a Neural Network and Machine Learning) of the likelihood of particular pick-up location and likely time of pick up. All of which supports the provision of the associated service which fulfils the order intended to be picked up.

1. An food and beverage product provisioning system to enable a mobile computer device having a location determination mechanism which can be polled or provides at a predetermined rate a location update of the mobile computer device, the mobile computer device executing an application wherein a user of the mobile has previously registered as a patron of the application and the mobile computer device application associating the patron with a unique identifier, and the application communicating a location update only when the application is in use, and the mobile computer device accepting from a user of the mobile computing device a created order for a selection of one or more products and services that the patron will only pay for after the order is fulfilled by receipt of the product or products, whereby the patron can pick-up the one or more products they ordered from an outlet which can fulfil the provision of the one or more products, and wherein the patron can change their intention to purchase the created order prior to fulfilment of the order, or they can choose not to pick up the created order since it was only an intention to purchase the created order, the food and beverage product provisioning system comprises:
at least one order display device, being located at each outlet, at least one order display device located at an outlet configured to receive information representative of a) an order for product or products; b) the patron associated with the order; c) a indictor to commence preparation of the order at the time of receipt of the received information or at a future time; and
a back-end computer server having a digital data storage and executable code configured:
to receive location updates from the mobile computer device;
to receive or generate the unique identifier of the patron and provide the unique identifier to the mobile computer device;
to receive an order for one or more product from the mobile computer device;
to store in the digital data storage and permit reading from the digital data storage:
a location for each outlet which can fulfil the provision of the one or more products;
a location update of the mobile computer device;
a unique identifier received from the mobile computer device;
the order for a selection of one or more products and services received from the mobile computer device;
associate the received order for one or more products and services with the unique identifier;
determine the likelihood of the mobile computing device entering an outlet based on repeatedly;
determining the distance between the location provided the mobile computer device and the location of each outlet;
determining based on the determined distances the likelihood that the mobile computer device will attend a particular outlet location: and
if the determined likelihood is greater than a predetermined likelihood;
communicate a predetermined action to the particular outlet: the action being make the order at a predetermined time; otherwise repeat the determination.

2. The food and beverage product provisioning system according to claim 1 wherein a predetermined time value is at least based on average mobility pace of the patron based on real time location determinations of the patron over a period or based on historical information of locations determinations of the patron over a period of time, and the distance the patron is determined to be from the outlet based on the latest location determination and the location of the nearest outlet.

3. The food and beverage product provisioning system according to claim 1 wherein the back-end computer server is adapted to dynamically adjust the time and location prediction of the pick-up of the order based on patron behaviour after the order intended to be purchased is sent from the mobile computer device.

4. The food and beverage product provisioning system according to claim 1 wherein the order can be purchased by the patron authorising the relevant charge by interacting with the mobile computer device application which is adapted to send that authorisation to the back-end server using the order display device.

5. The food and beverage product provisioning system according to claim 1 wherein the location of the order display device is the predetermined entrance of the outlet.

6. The food and beverage product provisioning system according to claim 1 wherein the location of the display device is the exit of the outlet.

7. The food and beverage product provisioning system according to claim 1 wherein confirmation of the completion of a purchase transaction can be provided to the mobile computer device by the back-end computer system using one or more information exchange mechanisms.

8. An food and beverage product provisioning system to enable a patron to use a mobile computer device application to create and communicate an order for one or more products or services available from any one or more outlets they intend to purchase, the system comprising:
a back-end computer server adapted to receive the communicated order from the patron and dynamically adjust a time and outlet location prediction of the pick-up of the order based on patron behaviour after the order is received, and at least one order display device being located at each outlet, configured to receive information representative of a) an order for product or services; b) the patron associated with the order; c) a indictor to commence the preparation of the order at the time of receipt of the information or at a future time, wherein the fulfilment of the order or lack of fulfilment of the order is at least one aspect of that patrons behaviour used in the time and outlet location prediction of the pick-up of the order.
